(19) United States
(12) Patent Application Publication
(10) Pub. No.: US 2023/0165183 A1
(43) Pub. Date: Jun. 1, 2023

(54) METHODS AND COMPOSITIONS FOR IMPROVED SEED GROWTH

(71) Applicants: Cyprus University of Technology, Limassol (CY); University of Cyprus, Aglantizia Nicosia (CY)

(72) Inventors: Vasileios Fotopoulos, Limassol (CY); Andreas Ioannou, Nicosia (CY); Theodora Krasia, Nicosia (CY); Kyriakos Athanasiou, Larnaca (CY)

(21) Appl. No.: 18/072,079

(22) Filed: Nov. 30, 2022

Related U.S. Application Data
(60) Provisional application No. 63/284,167, filed on Nov. 30, 2021.

(51) Int. Cl. A01C 1/06; C09D 105/04; A01N 25/04; C08K 5/3417; C09D 7/63

(52) U.S. Cl. CPC A01C 1/06; C09D 105/04; A01N 25/04; C08K 5/3417; C09D 7/63; A01N 2300/00

(57) ABSTRACT

Provided are methods and compositions for increasing plant resistance to abiotic stress. The composition may comprise a hydrogel and a priming agent. The methods may include contacting the seed with a seed coating composition comprising a hydrogel and a priming agent.

### CROSS REFERENCE TO RELATED APPLICATIONS

This application claims the benefit of U.S. Provisional patent application 63/284,167 filed Nov. 30, 2021, the entire contents of which is incorporated by reference herein.

### TECHNICAL FIELD

This disclosure relates to methods and compositions for “priming” seeds to achieve increased stress resilience, faster growth and increased productivity.

### BACKGROUND

Stress, such as climate change-related abiotic stresses including drought and heat, limits agricultural productivity worldwide. While efforts to minimize these impacts are ongoing, a complimentary approach involves techniques for treating seeds that can produce plants better-suited for resisting abiotic stresses.

For example, seed priming involves exposing seeds (often in a liquid medium) to priming agents in order to, for example, increase growth rates. While current seed priming techniques address, at least peripherally, some stress factors, limits on their effectiveness prevent optimum utilization of available resources.

### SUMMARY

Disclosed embodiments comprise compositions for priming seeds. In embodiments the seed priming compositions can comprise at least one priming agent. In embodiments, the seed priming composition comprises a biodegradable hydrogel such as a polysaccharide-based biodegradable hydrogel. In embodiments, the compositions can be extended-release compositions.

Disclosed embodiments comprise methods for producing seed priming compositions, for example compositions comprising a hydrogel.

Disclosed embodiments comprise methods for priming seeds.

Disclosed embodiments comprise methods of use of primed seeds.

### BRIEF DESCRIPTION OF THE DRAWINGS

FIG. 1 shows seedling growth of control and treated tomato plants.

FIG. 2 (left) depicts a leaf series analysis of projected L1 (leaf 1), L2 (leaf 2) and L3 (leaf 3) area (mm²); FIG. 2 (right) depicts projected L3 area (mm²); non-treated means “dry” (unprimed) seeds planted, “control” refers to hydroprimed seeds (treated with water—melatonin is water-soluble).

FIG. 3 depicts fresh plant weight in grams.

FIG. 4 depicts germination percentage five days after sowing (5 DAS) in tomato seeds coated (pre-treated) with melatonin concentrations (Mel 1=50 μM, Mel 2=100 μM) in comparison with unprimed seeds (non-treated) and hydrogel coated seeds (Hydro). Different letters denote significantly different values at p<0.05. Preliminary experiments on biocompatible/bioresorbable alginate hydrogel coatings on tomato seeds have shown that such coatings do not have a penalty in germination parameters, while priming of tomato seeds with melatonin have resulted in significantly increased germination percentage.

FIG. 5A-C shows preliminary kinetic release studies of melatonin from the crosslinked alginate hydrogels, revealing the sustained release of melatonin from alginate hydrogels and the dependence of the release rate on the concentration of the embedded melatonin. Kinetic studies were performed using UV-vis spectrophotometry, upon immersing the melatonin-containing alginate hydrogels in aqueous media. (FIG. 5A) Melatonin concentration 50 μM. (FIG. 5B) Melatonin concentration 100 μM. (FIG. 5C) Melatonin concentration 50 μM and 100 μM over time.

FIG. 6 shows stomatal conductance levels and 5^{th}-6^{th} true leaf FW of tomato plants at 30d (drought stress) and 31d (recovery).

### DETAILED DESCRIPTION

The present disclosure is based, at least in part, on the non-limiting theory that priming agents can be used to better-prepare or “prime” plants prior to exposure to abiotic stress factors, including fluctuations in water availability, fluctuations in temperature, fluctuations in salinity, and fluctuations in pH. Disclosed embodiments employ compounds that are effective stress primers and growth promoters, for example natural or synthetic compounds that can act via signal transduction, the process by which a chemical or physical signal is transmitted through a cell as a series of molecular events, most commonly protein phosphorylation catalyzed by protein kinases, which ultimately results in a cellular response.

For example, exposure of plants to red or blue light initiates developmental processes that prepare the plant to perform photosynthesis—chlorophyll and photosynthetic apparatus are produced, hypocotyl and stem elongation are suppressed, and the cotyledons and leaves unfold and expand.

In embodiments, seed priming is coupled with seed coatings that enable localized, controlled-release of the priming agent or agents into the seed. Through the use of described embodiments, primed seeds demonstrate lower physiological and cellular damage levels under drought conditions, as well as significantly increased leaf area as compared to non-primed controls.

### Definitions

“A” and “an” are used herein to refer to one or to more than one (i.e., to at least one) of the grammatical object of the article. By way of example, “an element” means one element or more than one element.

“Abiotic stress” is used to refer to deviations in a plant's typical growth environment, such as changes (increases or decreases) in pH, temperature, salinity, humidity, soil moisture, soil metal content, etc. Thus, abiotic stress can comprise temperature stress, water stress, pH stress, and salinity stress.

“Comprise,” “comprising,” “include,” “ding,” “have,” and “having” are used in the inclusive, open sense, meaning that additional elements may be included. The terms “such as”, “e.g.”, as used herein are non-limiting and are for illustrative purposes only. “Including” and “including but not limited to” are used interchangeably.

“Effective” and “effective amount” refer to that amount of priming composition that produces a beneficial result in a plant or seed after administration.

“In vitro” refers to an artificial environment and to processes or reactions that occur within an artificial environment. In vitro environments include, but are not limited to, test tubes and cell culture. The term “in vivo” refers to the natural environment (e.g., an animal or a cell) and to processes or reactions that occur within a natural environment.

“Hydrogel” refers to a three-dimensional network of hydrophilic polymers that can swell in water, and hold a large volume of water, while maintaining their structure due to chemical or physical cross-linking of individual polymer chains. Hydrogels also possess a degree of flexibility very similar to natural tissue due to their water content. The hydrophilicity of the network is due to the presence of hydrophilic groups such as NH₂, COOH, OH, CONH₂, CONH, and SO₃H. Hydrogels can be conjugated with various entities, including drug and chemical compounds.

“Or” as used herein should be understood to mean “and/or” unless the context clearly indicates otherwise.

“Phytohormone” or “plant hormone” refers to signal molecules produced within plants that occur in extremely low concentrations. Plant hormones control all aspects of plant growth and development including embryogenesis, regulation of organ size, pathogen defense, stress tolerance, through to reproductive development. In contrast to animals in which hormone production is restricted to specialized glands, each plant cell can produce phytohormones.

“Precursor seed” refers to the seed from which a specific plant grows.

“Signal transduction agent” means a chemical compound that initiates, modulates, or enhances a chemical or physical signal within a plant or seed.

“Treatment” or “treating” refers to any therapeutic intervention in a plant.

“Reducing,” “suppressing” and “inhibiting” have their commonly understood meaning of lessening or decreasing.

Seed Priming Agents

Disclosed embodiments comprise agents for priming seeds. For example, disclosed seed priming agents can comprise at least one agent that produces a physiological effect within the seed, such as a transcriptional effect, a translational effect, or a combination thereof. For example, priming agents can act to up- or down-regulate gene expression, which can then affect plant growth. Through the use of disclosed priming agents, seeds can be better-prepared to tolerate and thrive in environments that would otherwise limit their, for example, growth rate, germination rate, fruit production, flower production, or the like. Disclosed seed priming agents can provide stress protection and lead to growth promotion when applied at seed level.

Further disclosed embodiments comprise priming agents that can reduce the effect of abiotic stress upon a seed, for example abiotic stresses including drought, increased salinity, changes in pH such as increased or decreased alkalinity or acidity, changes in temperature such as increases or decreases, and combinations thereof.

Disclosed embodiments comprise priming agents that can increase plant growth rates, for example growth rates under conditions of abiotic stress. For example, disclosed embodiments comprise priming agents that can increase growth rates and/or result in lower cellular damage levels as quantified by cellular damage indicators (such as malondialdehyde content, proline content, electrolyte leakage, pigment content, reactive oxygen and nitrogen species content) under drought conditions by, for example, 10%, 20%, 30%, 40%, 50%, 60%, 70%, or more, as compared to unprimed seeds. Similarly, disclosed embodiments comprise priming agents that can increase growth rates in environments experiencing increased temperatures by, for example, 10%, 20%, 30%, 40%, 50%, 60%, 70%, or more, as compared to unprimed seeds. Further embodiments comprise priming agents that can increase growth rates in environments experiencing increased salinity by, for example, 10%, 20%, 30%, 40%, 50%, 60%, 70%, or more, as compared to unprimed seeds.

Further embodiments comprise priming agents that can increase plant germination rates, for example germination rates under conditions of abiotic stress. For example, disclosed embodiments comprise priming agents that can increase germination rates under drought conditions by, for example, 10%, 20%, 30%, 40%, 50%, 60%, 70%, or more, as compared to unprimed seeds. Similarly, disclosed embodiments comprise priming agents that can increase germination rates in environments experiencing increased temperatures by, for example, 10%, 20%, 30%, 40%, 50%, 60%, 70%, or more, as compared to unprimed seeds. Further embodiments comprise priming agents that can increase germination rates in environments experiencing increased salinity by, for example, 10%, 20%, 30%, 40%, 50%, 60%, 70%, or more, as compared to unprimed seeds.

Further embodiments comprise priming agents that can increase plant germination percentages, for example germination percentages under conditions of abiotic stress. For example, disclosed embodiments comprise priming agents that can increase germination percentages under drought conditions by, for example, 10%, 20%, 30%, 40%, 50%, 60%, 70%, or more, as compared to unprimed seeds. Similarly, disclosed embodiments comprise priming agents that can increase germination percentages in environments experiencing increased temperatures by, for example, 10%, 20%, 30%, 40%, 50%, 60%, 70%, or more, as compared to unprimed seeds. Further embodiments comprise priming agents that can increase germination percentages in environments experiencing increased salinity by, for example, 10%, 20%, 30%, 40%, 50%, 60%, 70%, or more, as compared to unprimed seeds.

Disclosed priming agents can comprise any agent that produces a desired effect on the seed, the plant that ultimately emerges from the seed, or a combination thereof. Non-limiting examples of such agents include fertilizers, energy sources, pesticides (such as fungicides, acaricides, miticides, insecticides, insect repellants, bird repellants, rodenticides, molluscicides, nematicides, bactericides, and fumigants), herbicides, chemical hybridizing agents, auxins, antibiotics and other drugs, biological attractants, growth regulators, pheromones and dyes. Specific non-limiting examples of chemical agents useful as priming agents include triticonazole, imidacloprid, tefluthrin, and silthiophenamide (N-allyl-4,5-dimethyl-2-trimethylsilylthiophene-3-caboxamide).

Suitable priming agents disclosed herein comprise, for example:

I. Pesticides:
A. Herbicides
   1. Phenoxy compounds 2,4-D MCPB 2,4,5-T Bifenox;
   2. Benzoic, acetic acids and phthallic compounds, chloramben, dicamba, bromoxynil, chlorthiamid;
   3. Dinitro analines, nitrites, amides, acetamides and anilides trifluralin, benefin, oryzalin, quinonamid;
   4. Carbamates butylate, asulam, thiobencard;
   5. Heterocyclic nitrogen derivatives picloram, aminotriazole, paraquat, simazine;
   6. Urea compounds diuron, bromacil, terbacil isoproturon;
   7. Metal organics and inorganics, DSMA;
   8. Other herbicides, petroleum oils, aromatic oils, oxyfluorfen, bentazon, fluridome;
B. Insecticides
   1. Cyclo compounds—endrin, heptachlor, lindane, mirex;
   2. Carbamate, carbofuran, isoprocarb;
   3. Animal plant derivation and inorganic compounds—rotenone, thiocyclam;
   4. Diphenyl compounds—DDT, methoxychlor, difluron, amitraz;
   5. Organic phosphates dicrotophos, parathion, malathion, phorate, Phosmet Penncap M® (Pennwalt Corp.) KnoxOut 2FM® (Pennwalt. Corp.);
C. Fungicides
   1. Inorganics—copper sulfate;
   2. Metal organics—cadminate (Mallinckrodt Chemical Works);
   3. Antibiotics and Bacteriocins—streptomycin, cycloheximide, piomy;
   4. Carbamates—ferbam, ziram, thiram;
   5. Organic fungicides—carboxin, captan, chloroneb, benomyl, metalaxyl;
   6. strobilurins;
D. Fumigants, Repellents and Rodenticides
   1. Fumigants—methyl bromide, carbon bisulfide, propylene dichloride, vapam;
   2. Repellents—thiram;
   3. Rodenticides—warfarin, endrin;

II. Fertilizers and Nutrients—nitrogen, phosphate, potassium, sulfur, calcium, magnesium, amino acids;

III. Energy Sources—sugars, carbohydrates, ATP;

IV. Microorganisms—Pseudomonas species, Azotobacter species, Cyanobacteria, Mycorrhizal fungi, Rhizobia species, Bacillus subtilis, Bacteroides ruminicola, Lachnospira multiparus, Aspergillus fumigatus, Fusarium oxysporum, Paecilomyces species, Flavobacterium species, Achromobacter species, Aspergillus species, Arthobacter species, Actinomycete species, Halophytic bacteria, Nitrosomonas species, Nitrobacter species, Sulfur mineralizing bacteria, Baculovirus species, Heliothis zea NPV Autographa Californica NPV;

V. Growth Regulators and Hormones—giberellic acid, cytokinins, ethoxyquin, naphthalene, acetic acid, indolebutyric acid, para-chlorophenoxyacetic acid, ethylene, indole;

VI. Other Biologically Active Components—denitrification inhibitors, iron chelators, pheromones, enzymes, pesticide antidotes, and safeners; VII. Other Inert Components—soil and water conditioners, dispersants, wetting agents, pH altering compounds.

Combinations of the above-disclosed materials are also disclosed herein. For for example, in an embodiment, a combination of a hormone and a fertilizer can act as a seed priming agent.

In embodiments comprising a hormone, the hormone can comprise, for example a plant hormone (phytohormone) or plant growth regulator (PGR). Phytohormones are chemical molecules produced by plants that play important roles in regulating plant growth and development.

Known phytohormones that are essential for plant growth and development include

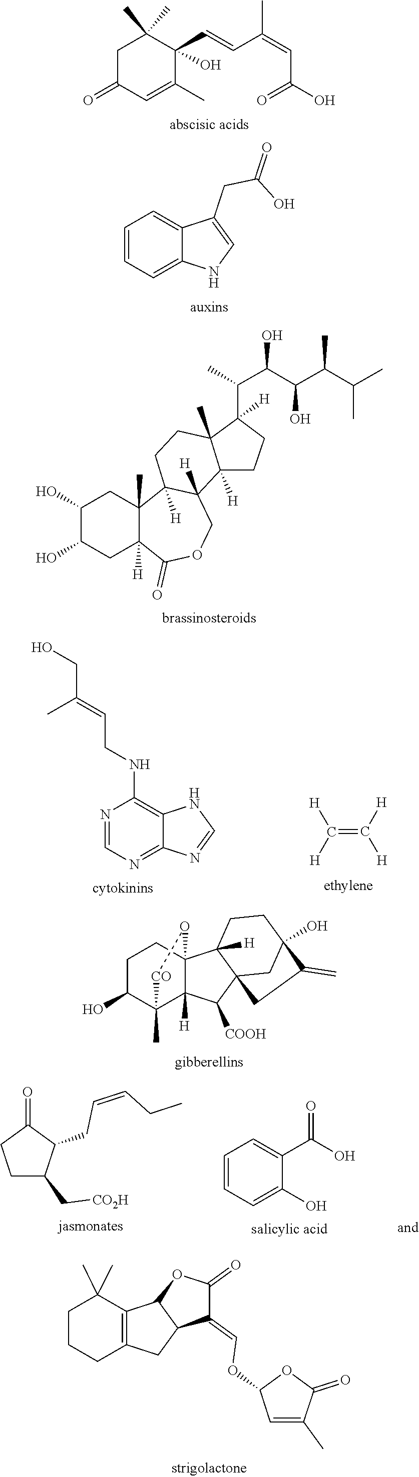

Disclosed hormone seed priming agents can produce physiological effects in a seed, plant, or combinations thereof. For example, exemplary cytokinin (CK) effects are listed in Table 1:

| Plant | Stress | Plant Response to CK |
|---|---|---|
| Soybean | Drought | Improved tolerance |
| Pigeon Pea | Salt | Prevented damage |
| Pigeon Pea | Cadmium | Improved tolerance |
| Basil | Drought | Reduced negative effects of drought stress |
| Basil | Salt | Decreased ABA concentration; enhanced |
| | | tolerance |
| Basil | Salt | Improved photosynthetic rate and water use |
| | | efficiency |
| Wheat | Salt | Decreased electrolyte leakage |
| Wheat | Salt | Enhanced ethylene production |
| Wheat | Salt | Increased tissue nitrogen content |

Exemplary gibberellin (GA) effects are listed in Table 2:

| Plant | Stress | Plant Response to GA |
|---|---|---|
| Pigeon Pea | Calcium | Increased germination |
| Pot Marigold | Salt | Increased tolerance |
| Milk Thistle | Salt | Alleviated salt stress |
| Chickpea | Drought | Increased relative water content |
| Wheat | Salt | Increased tolerance |
| Sorghum | Drought | Increased CAT and APX activities |
| Corn | Salt | Increased tissue water content |
| Maize | Salt | Alleviated salt stress |

Exemplary salicyclic acid (SA) effects are listed in Table 3:

| Plant | Stress | Plant Response to SA |
|---|---|---|
| Rice | Chromium | Increased chlorophyll content |
| Rice | Chilling | Enhanced antioxidant activity |
| Safflower | Drought | Enhanced antioxidant activity |
| Maize | Chilling | Enhanced antioxidant activity |
| Maize | Lead | Increased nitric oxide content |
| Wheat | Salinity | Decreased electrolyte leakage |
| Wheat | Drought | Balanced nutrient uptake |
| Wheat | Osmotic | Increased tolerance |

In embodiments, the priming agent can comprise, for example, melatonin:

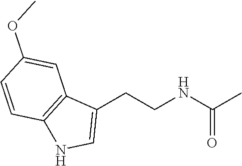 [SMILES: COc1ccc2[nH]cc(CCNC(C)=O)c2c1]

In plants, melatonin works synergistically with other antioxidants to improve the overall effectiveness of each antioxidant. Via signal transduction through melatonin receptors, melatonin promotes the expression of antioxidant enzymes such as superoxide dismutase, glutathione peroxidase, glutathione reductase, ascorbate peroxidase, and catalase. Further melatonin effects comprise lowering H₂O₂ and malondialdehyde concentrations and promoting starch metabolism.

In embodiments, melatonin-primed seeds display enhanced germination potential, germination rate, increased radicle length, increased hypocotyl length, increased root length, and increased seed vigor index compared with non-primed seeds under chilling stress.

Further priming agents suitable for use in disclosed embodiments comprise fertilizers, fertilizer additives, or growth enhancers that comprise a mixture of molecules that contain at least one molecule from two of the following groups: protein alpha-amino acids, non-protein alpha-amino acids, beta-amino acids, gamma-amino acids, methyl-amino acids, polyamines, macronutrients, micronutrients, sugars, organic acids, protein hydrolysates, humic acid, fulvic acid, and surfactants.

In embodiments, disclosed seed priming compositions can comprise a physiologically-acceptable carrier, for example an aqueous physiologically-acceptable carrier.

In embodiments, disclosed seed priming compositions can be prepared using acive agents that have been commercially obtained, or through the use of isolation techniques, for example chromatography. In embodiments, preparation of disclosed seed priming compositions can comprise suspension of the priming agent or agents in a physiologically-acceptable carrier.

Seed Coating Compositions

Disclosed embodiments can comprise compositions for coating seeds, for example compositions comprising a seed priming agent as described herein. In embodiments, the coating can be, for example, at least 0.5 mm thick, at least 0.6 mm thick, at least 0.7 mm thick, at least 0.8 mm thick, at least 0.9 mm thick, at least 1.0 mm thick, at least 1.1 mm thick, at least 1.2 mm thick, at least 1.3 mm thick, at least 1.4 mm thick, at least 1.5 mm thick, at least 1.6 mm thick, at least 1.7 mm thick, at least 1.8 mm thick, at least 1.9 mm thick, at least 2.0 mm thick, or the like.

In disclosed embodiments, seeds can be coated in any of numerous media which provide an appropriate encapsulation matrix. For example, disclosed embodiments comprise a biodegradable hydrogel comprising a seed priming agent.

Hydrogels are comprised of networks of polymer chains that are hydrophilic, in which water is the dispersion medium. They are highly absorbent and can contain over 99.9% water within natural or synthetic polymers. Hydrogels also possess a degree of flexibility very similar to natural tissue, due to their significant water content. Environmentally sensitive hydrogels are also known as “Smart Gels” or “Intelligent Gels” and these have the ability to sense changes of pH, temperature, or the concentration of metabolite and release a priming agent or other incorporated material as result of such a change. As such they are useful as sustained-release drug delivery systems and other uses where water absorption and retention is important.

In general, a hydrogel will allow seed respiration by permitting diffusion of gases. The gel should provide a capsule strong enough to resist external abrasion and adverse forces, yet pliable enough to allow the growth of the seed and its germination at the appropriate time. In embodiments, it may be desirable to use various hydrogels in combination, either as a mixture or in layers, to achieve the desired results. In view of the application in the environment, it is desirable that the hydrogel be one that is not an environmental pollutant. In embodiments, the hydrogel can be biodegradable.

Disclosed hydrogel seed coatings can comprise a gelatin-based hydrogel formulation consisting of a naturally-derived, hydrophilic protein in combination with a sulfated or non-sulfated polysaccharide. In embodiments, the protein may be animal such as porcine- or bovine-derived. In embodiments, the polysaccharide may be a cellulose derivative such as sodium cellulose sulfate, dextran sulfate, sulfated starch and mixtures thereof. The seed coating composition may also comprise a rheology modifier, comprising for example a clay, a dessicant or silica gel. In embodiments, the hydrogel coating can provide extended release of a priming agent and reduce the need for repeated watering to saturate the seed during early stages of germination initiation, as the hydrogel water retention and slow release profiles provide a reservoir of water that the seed can draw upon on demand.

In embodiments, the sulfated polysaccharide can comprise, for example, sodium cellulose sulfate, dextran sulfate, and sulfated starch. Neutral (unsulfated) polysaccharides may be selected from the group comprising cellulose, dextran, starch. The sulfated starches may be those derived from corn, potato, rice and/or soy and these are of particular interest because these are renewable, widely available plant-based materials. Disclosed polysaccharide compounds comprise dextran or starch, such as corn and plant-derived starches.

In embodiments, the hydrogel can comprise at least one of guar gum, carrageenan, locust bean gum, sodium alginate with gelatin, carboxymethylcellulose, gum tragacanth, sodium pectate, vinyl acetate, Furcellaran, pectin, hypnean, dextran, tamarind, amylose, agar, agarose, agar with gelatin, starch, amylopectin, cornhull gum, starch arabogalactan, gum ghatti, gum karagan, Ti gum, wheat gum, chitin, dextrin, ethyl succinylated cellulose, succinylated zein, methylcellullose, hydroxyethyl cellulose, gelatin with glutaraldehyde, polyacrylamide, polyethylene glycol, polyvinylpyrrolidone, polyoxyethylene, hydrophillic urethane, polyvinylacetate, vinyl resins, Hydron (hydroxyethylmethacrylate), 2-methyl-5-vinylpyridine-methylacrylate-methylacrylic acid, sodium polystyrene sulfonate with polyvinylmethylpyridinium chloride, sodium polystyrene sulfonate with polyvinylbenzyltrimethylammonium chloride, strongly acidic polyanions with strongly basic polycations, Bordon Poly Co. 2113® (vinyl acetate homopolymer), GELVATOL® (polyvinyl alcohol resin), SUPER SLURPER®, VITERRA®, LAPONITE®, GELRITE®, SEAKEM®, SEAPLAQUE®, SEAPREP®, ISOGEL®, methylan clear wallpaper paste, lactose, wax, clay, fly ash, feldspar, celrite, bentonite, vermiculite, diatomaceous earth, lime, calcium carbonate, calcium oxide, magnesium carbonate, sodium bicarbonate and urea.

In embodiments, the seed coating composition comprises an alginate. Alginate, also called alginic acid, is a compound found within the cell walls of brown algae that is extracted from cells as a polysaccharide. Disclosed hydrogel coatings comprise sodium alginate, calcium alginate, and the like.

For example, a sodium alginate solution will form a water saturated gel when a complexing agent is added. In disclosed embodiments, calcium chloride (CaCl₂) is used as a complexing agent, however, other chlorides such as lanthanum chloride, ferric chloride and cobaltous chloride, calcium nitrate, calcium hydroxide, superphosphate fertilizer, and many pesticides such as benefin, alachlor and chlorpropham are also acceptable, as are other compounds generally with multivalent cations.

In embodiments, the step of adding a complexing agent such as calcium chloride is omitted. Since this step is responsible for the solidification of the conjugates (and thus the formation of the seed coating), omitting this step allows the conjugates to remain in the soluble state. Having the conjugates in the soluble state permits the formulations to be sprayed on seedlings and/or mature plants. In embodiments, the main benefit of spraying over seed treatment is found in the species-specific needs, where in cases it is not possible to apply priming treatments at seed level such as with soft fruit and fruit crops. Treatments in such cases can be done on seedlings, plants/trees, rhizomes, suckers etc as it is not possible to grow (soft) fruit crops from seed in commercial scale.

In embodiments, any type of hydrogel sprayable formulation may be used (e.g., microgels and nanogels).

In embodiments, a chloroinconazide (CHI)-loaded alginate-based nanogel (CHI@ALGNP) may be used as a spray.

The alginate-based nanogel may be applied to the spray-based pesticide delivery technology. Antiviral compounds such as CHI may improve the efficiency and duration of pesticides. The CHI@ALGNP may be directly sprayed onto the leaf surface of the plants. The CHI@ALGNP exhibits higher foliar adhesion than CHI alone.

In embodiments, the hydrogel can have a range of appropriate concentrations. The gel concentration can be chosen to optimize ease of handling, gelling time, gel strength and gel coating thickness around the seed. If the gel is too dilute, the seed may settle during gel formation and produce an uneven encapsulation. The sodium alginate, for example, can be prepared in a concentration of 1 to 10% w (in grams)/v (in milliliters) in water, more usually 2 to 10% and preferably from 3 to 5%.

The seed to be coated can then be added to the sodium alginate solution at a concentration of 1 to 50 seeds per milliliter, typically from 5 to 20 seeds per milliliter. This concentration will vary as the appropriate size of the seeds varies with species and source.

Specific priming agents to be encapsulated with the seed, for example melatonin, can then be added to the sodium alginate and seed solution. The dispersed priming agents and seeds in gel solution can then be added dropwise to the complexing agent. Alternatively, the gel solution and complexing agent may be mixed by any of numerous techniques known to the art to obtain encapsulated seeds. These may include droplet formation and agent addition as a one step process by a vibrating nozzle which ejects a gel droplet from one source and coats the droplet with complexing agent from another.

The time for gel formation and the temperature of the gelling solutions are interrelated parameters, for selected concentrations of gel and complexing agent. The temperature should be chosen so as to avoid damage to the meristematic tissue, usually in the range of 1° C. to 50° C., more usually 10° C. to 40° C., and preferably at 20° C. to 40° C.

Within the range of acceptable temperatures, a particular value can be chosen to give the shortest possible gelling time consistent with complete gel formation. Typically, the gel will form immediately, but the complexation takes much longer. As an example, for a solution of sodium alginate at a concentration of 3.2 grams per 100 milliliters H₂O, calcium chloride solution concentration of 50 millimolar and 25° C. reaction temperature, adequate gelling is obtained in 5 to 120 minutes, more often 10 to 90 minutes and is usually sufficiently complete in 30 to 60 minutes. Alternatively, if 300 millimolar calcium chloride is substituted for 50 millimolar calcium chloride, gelling time is decreased to 2 to 5 minutes.

The gel characteristics are determined generally by the concentration parameters and chemical properties of the gel.

Seed Priming Compositions

In embodiments, preparation of disclosed seed priming compositions can be accomplished by, for example, mixing a seed priming agent such as a plant hormone with a seed coating composition, for example a gel such as a hydrogel.

Methods of Priming Seeds

Disclosed methods comprise methods of priming seeds. Disclosed methods comprise applying a seed priming composition to a seed. For example, disclosed seed priming methods can comprise application of a seed priming composition to plant seeds by any known method in the art. For example, the seed priming compositions may be dissolved in water or another suitable liquid and the solution may be sprayed on the seeds. In embodiments, the seeds can be immersed in a solution comprising at least one seed priming composition. For example, the seed may be soaked, sprayed, immersed, misted, or the like, to coat the seed with the seed priming composition. In embodiments, the concentration of the seed priming agent in the liquid seed priming composition can be, for example, 5 μM, 10 μM, 15 μM, 25 μM, 50 μM, 100 μM, 200 μM, 300 μM, 400 μM, 500 μM, 600 μM, 700 μM, 1000 μM or the like.

Disclosed methods can comprise the use of seeds that have been frozen. For example, seeds can be frozen prior-to or following a priming step, then thawed for further use. Thus, in embodiments, a priming composition can be applied to a seed before or after freezing the seed.

In embodiments, controlled release techniques may be employed in any of several ways (or in a combination of such ways). For instance, disclosed primed seeds may be encapsulated in a controlled release formulation, or the particles of a priming agent distributed through the hydrogel in the coating may be coated with a controlled release formulation, or the priming agent may be mixed with the controlled release agent, or the controlled release agent may be dispersed through the coating. Any of these techniques may be used alone or in combination to enhance even further the controlled (i.e., delayed) release provided by either the controlled release formulation itself or the controlled release detected with the present invention even without such formulation.

Methods of Use

Plant seeds appropriate for use with disclosed compositions and methods can comprise, for example, seeds that produce bushes, trees, decorative or recreational plants or crops, but are particularly useful for treating seeds for commercial and ornamental crops. Examples of plant seeds that can be used with the present invention include, but are not limited to, Acacia, alfalfa, almond, aneth, apple, apricot, artichoke, arugula, asparagus, avocado, banana, barley, beans, beech, beet, Bermuda grass, bent grass, blackberry, blueberry, Blue grass, broccoli, Brussels sprouts, cabbage, camelina, cannabis, canola, cantaloupe, carinata, carrot, cassava, cauliflower, celery, cherry, chicory, cilantro, citrus, clementine, coffee, corn, cotton, cucumber, duckweed, Douglas fir, eggplant, endive, escarole, eucalyptus, fennel, fescue, figs, forest trees, garlic, gourd, grape, grapefruit, honey dew, jicama, kiwifruit, lettuce, leeks, lemon, lime, Loblolly pine, maize, mango, melon, mushroom, nectarine, nut, oat, okra, onion, orange, an ornamental plant, palm, papaya, parsley, pea, peach, peanut, pear, pepper, persimmon, pine, pineapple, plantain, plum, pomegranate, poplar, potato, pumpkin, quince, radiata pine, radicchio, radish, rapeseed, raspberry, rice, rye, rye grass, seaweed, scallion, sorghum, Southern pine, soybean, spinach, squash, strawberry, sudangrass, sugar beet, sugarcane, sunflower, sweet potato, sweetgum, Swiss chard, switchgrass, tangerine, tea, tobacco, triticale, turf, turnip, a vine, watermelon, wheat, yams, and zucchini.

Disclosed embodiments comprise application of disclosed seed priming agents to seeds of terrestrial plants such as cereal crops such as wheat, vegetable crops such as tomatoes, ornamentals including flowering plants, and the like. For example, seeds from plants belonging to the Solanaceae family of flowering plants such as the tomato, pepper, potato, and eggplant, can be employed in disclosed embodiments.

Disclosed methods can be employed with seed plants of any species. However, they are preferably seeds of plant species that are agronomically important. Of particular importance are corn, peanut, canola/rapeseed, soybean, curcubits, crucifers, cotton, rice, sorghum, sugar beet, wheat, barley, rye, sunflower, tomato, sugarcane, tobacco, oats, as well as other vegetable and leaf crops.

In embodiments, the seed is transgenic, for example a seed engineered to express a desirable characteristic and, in particular, to have at least one heterologous gene encoding for the expression of a protein that is pesticidally active and, in particular, has insecticidal activity. The heterologous gene in the transgenic seeds and plants of the present invention can be derived from a microorganism such as, for example, Bacillus, Rhizobium, Pseudomonas, Serratia, Trichoderma, Clavibacter, Glomus, Gliocladium and mycorrhizal fungi.

The present disclosure also comprises methods to enhance seed protection and propagation, that comprise coating the seed with the hydrogel comprised of a gelatin/polysaccharide matrix/formulation which is then dried thereon. The seeds are first coated with the bio-degradable hydrogel that is then dried and hardened onto the seed coat by thermal exposure at a temperature of from about 20 to about 70° C. Optionally, the water content of the hydrogel formulation after preparation may be subsequently reduced by from about 1.0% to about 20.0% by the replacement of a portion of the water in the hydrogel formulation with an alcohol prior to coating the seeds in order to speed the drying process.

In embodiments, drying the primed seeds can comprise heat drying, vacuum drying, convection drying, drum drying, freeze drying, microwave-vacuum drying, shelf drying, spray drying, infrared radiation drying, and combinations thereof. For example, in embodiments comprising the use of heat drying, the hydrogel coating can be slowly evaporated onto the seed coat by the application of low heat between 20° C. and 70° C., this being an effective means to form a dry shell about the seed in as little as one hour.

### EXAMPLES

The following non-limiting examples are provided for illustrative purposes only in order to facilitate a more complete understanding of representative embodiments. These examples should not be construed to limit any of the embodiments described in the present specification.

### Example 1—Melatonin Seed Priming in Tomato

Tomato seeds were primed with melatonin at the following concentrations: 5 μM, 10 μM, 15 μM, 25 μM, 50 μM, 100 μM, 200 μM, and 300 μM. Priming was performed by soaking the seeds in the desired melatonin concentration, then vacuum-drying the seeds.

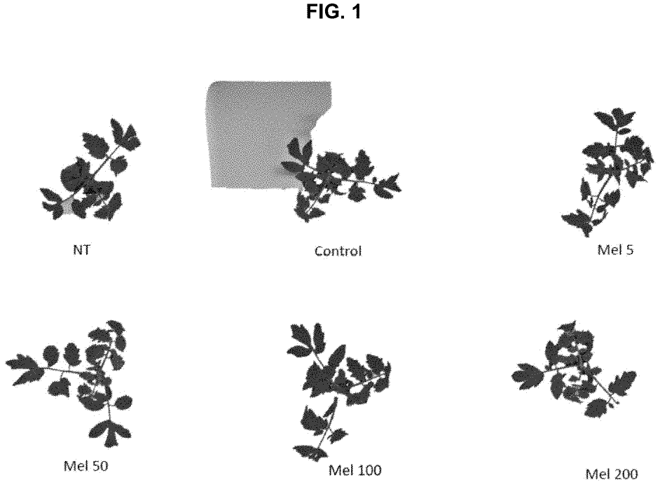

Seeds were harvested 21 days after sowing. FIG. 1 shows seedling growth of control and treated tomato plants.

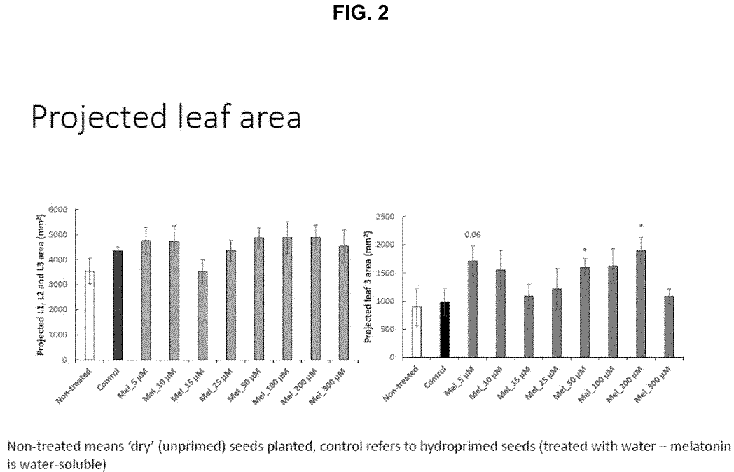

FIG. 2 (left) depicts projected L1, L2 and L3 area (mm²); FIG. 2 (right) depicts projected L3 area (mm²); non-treated means “dry” (unprimed) seeds planted, “control” refers to hydroprimed seeds (treated with water—melatonin is water-soluble).

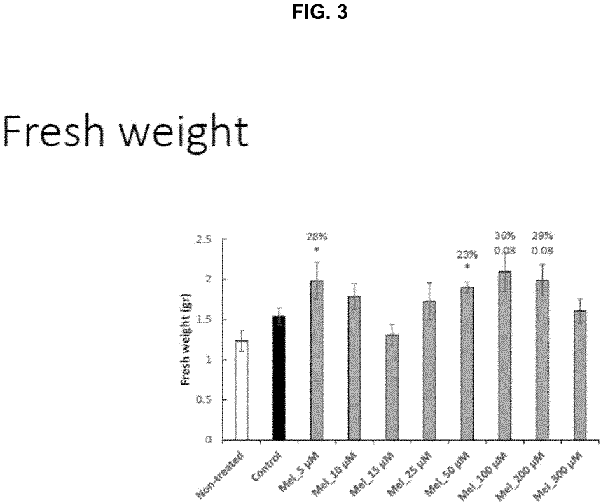

FIG. 3 depicts fresh plant weight in grams.

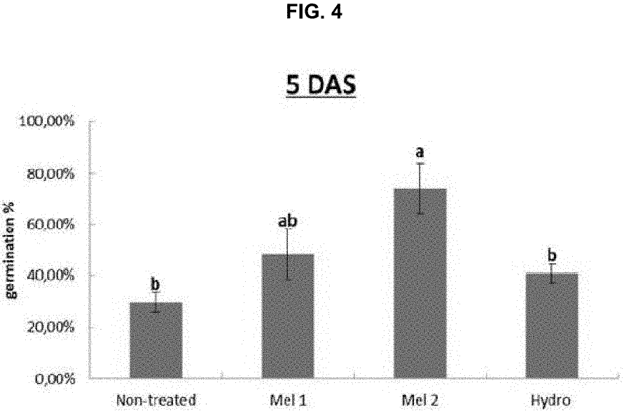

FIG. 4 depicts germination percentage five days after sowing (5 DAS) in tomato seeds coated pre-treated with melatonin concentrations (Mel 1=50 μM, Mel 2=100 μM) in comparison with unprimed seeds (Non-treated) and hydrogel coated seeds (Hydro). Different letters denote significantly different values at p<0.05. Preliminary experiments on biocompatible/bioresorbable alginate hydrogel coatings on tomato seeds have shown that such coatings do not have a penalty in germination parameters, while priming of tomato seeds with melatonin resulted in significantly increased germination percentage.

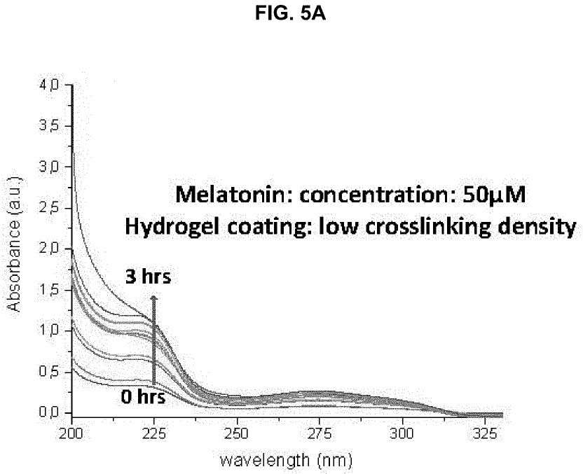

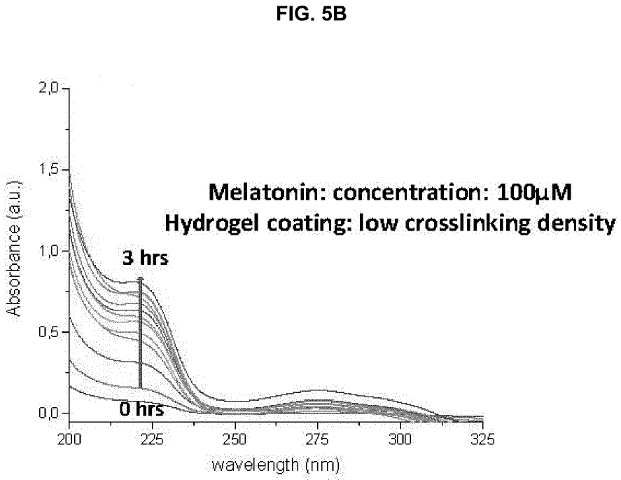

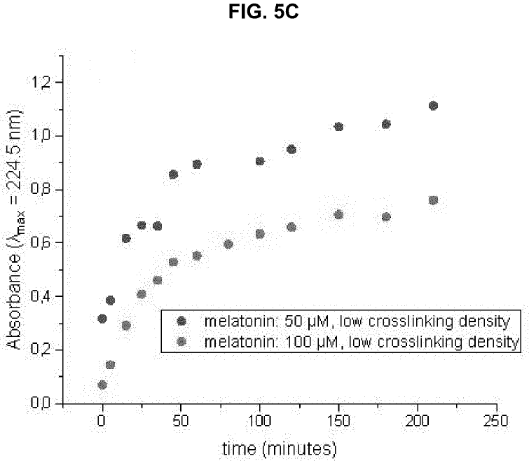

FIG. 5 shows preliminary kinetic release studies of melatonin from the crosslinked alginate hydrogels, revealing the sustained release of melatonin from the hydrogels and the dependence of the release rate on the concentration of the embedded melatonin. Kinetic studies were performed by UV-vis spectrophotometry, upon immersing the melatonin-containing alginate hydrogels in aqueous media.

### Example 2—Melatonin Seed Priming in Pepper

Pepper seeds are primed with a melatonin-containing alginate hydrogel at the following melatonin concentrations: 5 μM, 10 μM, 15 μM, 25 μM, 50 μM, 100 μM, 200 μM, and 300 μM. Priming is performed by soaking the seeds in the desired melatonin concentration, then IR-drying the seeds.

Seeds are harvested 21 days after sowing. Under heat stress, the primed seeds show an increased germination rate as compared to unprimed pepper seeds.

### Example 3—Melatonin Seed Priming in Lettuce

Lettuce seeds are primed with a melatonin-containing hydrogel at the following melatonin concentrations: 5 μM, 10 μM, 15 μM, 25 μM, 50 μM, 100 μM, 200 μM, and 300 μM. Priming is performed by soaking the seeds in the desired melatonin concentration, then drying the seeds with a bed dryer.

Seeds are harvested 21 days after sowing. Under drought conditions, the primed seeds at several concentrations show an increased germination percentage as compared to unprimed lettuce seeds.

### Example 4—Salicylic Acid Seed Priming in Beets

Beet seeds are primed with a salicylic acid-containing hydrogel at the following salicylic acid concentrations: 5 μM, 10 μM, 15 μM, 25 μM, 50 μM, 100 μM, 200 μM, and 300 μM. Priming is performed by soaking the seeds in the desired salicylic acid concentration, then drying the seeds with a drum dryer.

Seeds are harvested 21 days after sowing. Under high-alkalinity growth conditions, the primed seeds at several concentrations show an increased growth rate as compared to unprimed beet seeds.

### Example 5—Cytokinin Seed Priming in Eggplant

Eggplant seeds are primed with a cytokinin-containing hydrogel at the following cytokinin concentrations: 5 μM, 10 μM, 15 μM, 25 μM, 50 μM, 100 μM, 200 μM, and 300 μM as well as a fertilizer. Priming is performed by soaking the seeds in the desired cytokinin concentration in the presence of the fertilizer, then heat-drying the seeds.

Seeds are harvested 21 days after sowing. Under high-salinity growth conditions, the primed seeds at several concentrations show an increased growth rate as compared to unprimed eggplant seeds.

### Example 6—Hydrogel Coating of Corn Seeds

Corn seeds are coated with a hydrogel (succinate-modified potato starch) and with an equilibrium water absorption capacity of 260 g distilled water (DW)/g hydrogel. To coat corn seeds, the seeds are slightly wetted with an aqueous adhesive solution and then, in a closed container, mixed with a dry mixture of the modified starch (MS), bentonite, and talc. At a water supply of 77% field capacity (FC), the coated seeds show a significantly higher rate of emergence than uncoated seeds.

### Example 7—Hydrogel Coatings Functionalized with Melatonin on Tomato Seeds

The effect of hydrogel coatings functionalized with melatonin on tomato seeds was examined under water deficit conditions (drought stress), focusing on recovery performance evaluation after a single rewatering event. The treatments were as follows:

Untreated tomato seeds

Hydroprimed seeds (soaked in dH₂O)

Melatonin-primed seeds

Hydrogel-coated seeds

Hydrogel/melatonin-coated seeds

Plant Material, Stress Conditions and Treatments

Melatonin was prepared in a stock solution of 500 μM using warm water under constant stirring for 20 minutes at 60° C. The working solutions were made by diluting the stock in water to reach a concentration of 50 μM. Seed priming was performed by soaking tomato seeds (cv. ‘Ailsa Craig’) in melatonin solution and some in water for control. This procedure lasted for 12 hours at 25° C. in the dark. Then the seeds were placed in gauze under the laminar flow for airdrying, till reaching their initial weight. For the production of hydrogels, 50 mg of sodium alginate and 30 mg of calcium chloride were diluted in 4 ml and 1 ml of water, respectively. In case of hydrogel conjugates, we diluted these two chemicals with 50 μM of melatonin. Each gel was produced by soaking a seed in 16 μl sodium/alginate solution and then with the addition of 4 μl of calcium chloride. Then the seeds were placed on a petri dish under the laminar flow for airdrying for approximately 1 hour.

The seeds were sown in plastic seedling trays (1 seed per pot) filled with sterile soil, covered with a transparent film, and let to germinate in a growth chamber room under certain conditions of 24/20° C. day/night temperatures, 60-70% RH, with a photosynthetic photon flux density of 120 μmol m2 s−1 and a 16/8-h photoperiod. At day 8 after sowing, seedlings were transplanted into square plastic pots filled with sterilized pot soil, transferred into a growth room, and let to grow until day 24. Growing plants were watered three times per week.

In order to examine the effects of the application of the above solutions and conjugates (and their combinations) in plants under drought stress, starting at 25^{th} day, half of the plants were left without water for five days straight (severe stress). Measurements and leaf tissue collection took place at the starting point (25^{th} day) of stress and at the end of stress (30th day). At that time-point, plants were rewatered to saturation (pot drip-off) in a single rewatering event, and samples were obtained 24 h later (31^{st} day).

Stomatal conductance was measured with a DT-Porometer AP4 (Delta-T Devices, Cambridge, UK) following the manufacturer's instructions. All analyses were carried out using nine independent plants per treatment.

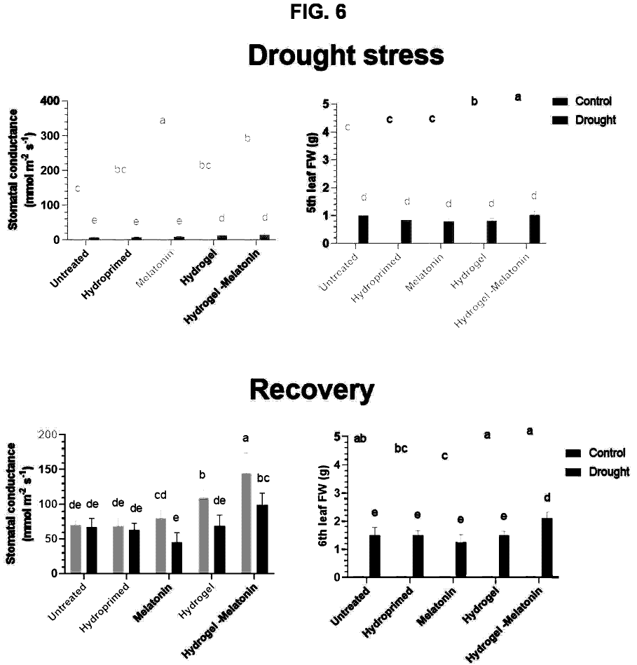

Measurement of stomatal conductance indicative of the physiological state of the plant indicated that drought-stressed plants had significantly lower stomatal conductance levels compared with watered plants indicative of a stressed state, while hydrogel and hydrogel/melatonin-coated seeds undergoing drought stress had significantly higher stomatal conductance compared with untreated, hydroprimed and melatonin-treated ones (FIG. 6). Importantly, conductance levels following a single rewatering event, showed that both watered as well as drought-stressed plants had significantly higher levels following hydrogel/melatonin coating of seeds, compared with any other treatment, suggesting that they possess optimal capacity for recovery from severe water deficit. This was actually supported from relevant agronomic parameters (6^{th} true leaf FW), where the drought-stressed, hydrogel/melatonin-coated plants had significantly higher FW values compared with all other treatments.

The foregoing findings show that hydrogel/melatonin-coated tomato seeds display statistically significant improvement in physiological (stomatal conductance) and agronomic parameters (6^{th} true leaf Fresh Weight) in severely drought-stressed plants that underwent a single rewatering event, indicating their superior capacity for recovery in comparison with untreated, hydroprimed, melatonin-treated as well as hydrogel-coated seeds.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1) A seed coating composition comprising a hydrogel and a priming agent.

2) The composition of claim 1, wherein said hydrogel comprises an alginate hydrogel.

3) The composition of claim 2, wherein said alginate hydrogel is cross-linked.

4) The composition of claim 3, wherein said priming agent comprises a signal transduction agent.

5) The composition of claim 4, wherein said signal transduction agent comprises a phytohormone.

6) The composition of claim 5, wherein said phytohormone comprises melatonin.

7) The composition of claim 6, wherein said melatonin is present at a concentration of between 5 μM and 300 μM.

8) The composition of claim 7, wherein said melatonin is present at a concentration of between 10 μM and 200 μM.

9) The composition of claim 8, wherein said melatonin is present at a concentration of between 25 μM and 100 μM.

10) The composition of claim 7, wherein said melatonin is present at a concentration of 5 μM.

11) A method of priming seeds, comprising contacting the seed with a seed coating composition comprising a hydrogel and a priming agent.

12) The method of claim 11, wherein said hydrogel comprises a conjugated hydrogel.

13) The method of claim 12, wherein said conjugated hydrogel comprises an alginate hydrogel.

14) The method of claim 11, wherein said priming agent comprises a signal transduction agent.

15) The method of claim 14, wherein said signal transduction agent comprises a phytohormone.

16) The method of claim 15, wherein said phytohormone comprises melatonin.

17) The method of claim 11, further comprising drying the coated seed.

18) The method of claim 17, wherein said coating is at least 1 mm thick.

19) A method of increasing a plant's resistance to abiotic stress, comprising contacting a precursor seed with a seed coating composition comprising a hydrogel and a priming agent, then drying the seed.

20) The method of claim 19, wherein said hydrogel comprises a conjugated hydrogel.

21) The method of claim 20, wherein said conjugated hydrogel comprises an alginate hydrogel.

22) The method of claim 19, wherein said priming agent comprises a signal transduction agent.

23) The method of claim 22, wherein said signal transduction agent comprises a phytohormone.

24) The method of claim 23, wherein said phytohormone comprises melatonin.

25) The method of claim 19, wherein said abiotic stress comprises at least one of temperature stress, water stress, pH stress, and salinity stress.

26) The method of claim 25, wherein said seed coating composition is at least 1 mm thick.

27) The method of claim 19, wherein said drying comprises heat drying.

28) The method of claim 19, wherein said drying comprises vacuum drying.

29) The method of claim 24, wherein said melatonin is present at a concentration of between 5 μM and 300 μM.

30) The method of claim 29, wherein said melatonin is present at a concentration of between 10 μM and 200 μM.

31) The method of claim 30, wherein said melatonin is present at a concentration of between 25 μM and 100 μM.

32) The method of claim 29, wherein said melatonin is present at a concentration of 5 μM.

33) The method of claim 19, wherein said drying comprises freeze drying.

34) The method of claim 19, wherein said drying comprises convection drying.

35) A method of priming seeds, comprising spraying the seed with a composition comprising a priming agent.

36) A method of promoting plant growth, comprising spraying the plant with a composition comprising a priming agent.
